(19) United States
(12) Patent Application Publication
(10) Pub. No.: US 2014/0122323 A1
(43) Pub. Date: May 1, 2014

(54) System and Method of Providing Monitoring Service on Demand

(71) Applicant: HONEYWELL INTERNATIONAL INC., Morristown, NJ (US)

(72) Inventor: Kenneth L. ADDY, Massapequa, NY (US)

(73) Assignee: Honeywell International Inc., Morristown, NJ (US)

(21) Appl. No.: 13/661,074

(22) Filed: Oct. 26, 2012

(51) Int. Cl. G06Q 20/08

(52) U.S. Cl. CPC G06Q 20/08
USPC 705/39

(57) ABSTRACT

A regional security system can be operated in an unmonitored state, a locally monitored state or a remotely monitored state. Monitoring by a displaced monitoring service can be provided on demand, in the absence of a pre-established account, for intermittent time intervals as needed. The request for activation of the displaced monitoring service can be entered via wireless communications devices such as smart phones, computers, tablets, smart cards or the like, along with scheduling information and duration of the requested monitoring. Such monitoring can also be terminated from any one of such devices.

### FIELD

The application pertains to regional security systems. More particularly, the application pertains to such systems which can operate on an unmonitored basis, but wherein third party monitoring can be provided on-demand.

### BACKGROUND

Residential and commercial security monitoring systems can effectively provide indicators of alarm, or event indicating conditions such as intrusions, smoke, gas, fire, water leakage or the like. In response to such indicators, first responders such as fire or police services can be contacted. The contact usually requires some form of recognition and then communications to the appropriate service.

Current residential and commercial security systems are unmonitored, self-monitored, or, are professionally monitored by a central station, or third party monitoring service. Unmonitored and self-monitored systems do not require paying a monthly monitoring fee to a displaced monitoring station, or, other third party monitoring service, and are increasingly popular. The disadvantage however is that an event may be missed. In that event, police/fire services might not be dispatched to a building.

For those people who are reluctant to pay a regular monthly fee for security monitoring, it would be advantageous to be able to order “monitoring-on-demand”. For example, if a home owner is leaving town for a weekend they might want professional monitoring of the home. However they might not want monitored security for the rest of the week when they are at home since security may not have the same value proposition at those times. An analogy may be “zipcar” where city dwellers who use the subway during the week might only need a car for an occasional weekend retreat upstate.

One way of providing monitoring-on-demand would be to build a central station business model where the account is only charged for an “arm-away” event. A disadvantage is that the account holder is still captive to the pricing of a single central station.

### BRIEF DESCRIPTION OF THE DRAWINGS

FIG. 1 illustrates a system in accordance herewith.

### DETAILED DESCRIPTION

While disclosed embodiments can take many different forms, specific embodiments hereof are shown in the drawings and will be described herein in detail with the understanding that the present disclosure is to be considered as an exemplification of the principles hereof, as well as the best mode of practicing same, and is not intended to limit the claims hereof to the specific embodiment illustrated.

In embodiments hereof a monitoring-on-demand service could directly undertake requested monitoring of a regional security system, or could redirect messages for service to the physically closest, or to the lowest bidding central station service. For example a service provided by Honeywell International, Inc. assignee of this application, commercially offered under brand name, ALARMNET, could be used to gather “armed away” events and establish a monitoring session (pay per hour or pay per day) with an established monitoring station with the lowest rates, or it could directly provide monitoring for these variable, or, fixed term sessions. The method of payment should be flexible, and convenient, preferably electronic, as this type of customer does not want a fixed monthly contract. For example, a pay-per-use arrangement, via a mobile phone based electronic wallet near field communications (NFC) system can be used.

In one aspect, an NFC reader can be incorporated into a security system. When the associated phone or smart card is swiped/held/bumped or moved in the reader field, the system recognizes a request for monitoring, arms-away, and deducts a payment for a predetermined arming period. The associated central station, or alternatively a brokered central station provided via a redirection service such as the ALARMNET service, then begins monitoring the system for the fixed period, or until the phone, or card, is re-swiped to stop monitoring. Charges and associated payments also cease.

The NFC payment method provides a secure, simple, one-time payment method and provides the advantages of unmonitored security (no monthly fee) with those of a monitored system—i.e., police/fire response when needed. In accordance herewith, a method for providing “monitored security on demand” can include NFC transceivers for a financial transaction to enable/disable security system monitoring. Advantageously, such methods provide intermittent professional third party system monitoring when the occupant or user of the monitored space is out of town or otherwise unavailable to self-monitor the system and premises.

In another aspect, payment can be implemented from a website using a credit card for a real-time payment, or, via a service such as PAYPAL and a user's pre-paid account. Payments could also be made at a retail kiosk.

Service activating devices can also include wireless tablets, personal digital assistant-type products, or computers without limitation. Keyboards associated with the respective security system can also be enabled to receive demands for monitored security. Dates and, or time durations can also be specified by any of the entry devices.

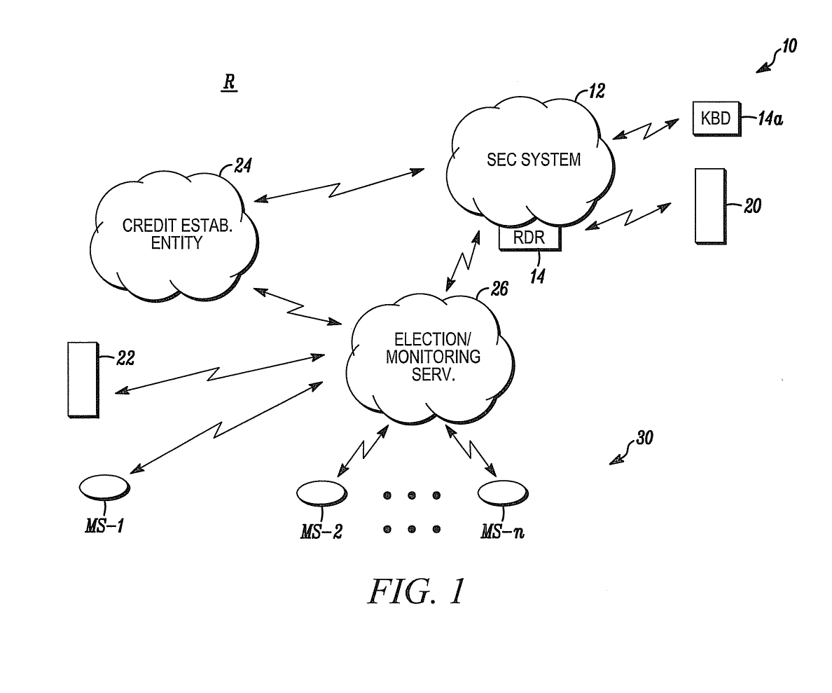

FIG. 1 illustrates an exemplary apparatus 10 in accordance herewith. As in FIG. 1 a security system 12 is installed and senses a variety of conditions in a region R. Such conditions include, without limitation, sensing intrusion, the presence of gases, fire or the like without limitation. One such security system has been disclosed in previously filed U.S. utility patent application Ser. No. 13/438,722, filed, Apr. 3, 2012, entitled System and Method for Providing Security on Demand, assigned to the assignee hereof and incorporated by reference herein.

Security system 12 can include a near field communications reader 14 which can communicate wirelessly with a user device 20. Device 20 can include without limitation, smart phones, smart cards or the like. As discussed above such instruments can be used to enter a demand for monitoring and establish the required credit, or payment arrangements via a credit or payment system 24 with which the system 12 can communicate for example via the Internet.

Demands for monitoring of the operation of system 12 can also be entered by a user via internet enabled tablets or computers, such as unit 22, without limitation. Alternately, a security system, keyboard 14a, in wired or wireless communication with system 12 can be used to enter the request for monitoring service, and specify schedule and duration as needed.

Requests for monitoring can be forwarded, for example by system 12, or the credit establishing entity 24, to an election/monitoring element 26 which can evaluate the request, and determine if unit 26 should carry out the monitoring or if the request should be forwarded to a member of a plurality 30 of available monitoring stations/ services MS-1 . . . MS-n. Evaluation of a monitoring station MS-i can be based on location, duration that monitoring has been requested, financial issues based on information received from entity 24 or the like, all without limitation.

In summary, monitoring-on-demand can be provided for a residential or commercial security system as requested. Coverage periods and payment arrangements can be entered. An evaluation can be carried out to determine which one, of an available plurality of monitoring services, should be selected to implement the requested monitoring.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

Further, logic flows depicted in the FIGURES do not require the particular order shown, or sequential order, to achieve desirable results. Other steps may be provided, or steps may be eliminated, from the described flows, and other components may be add to, or removed from the described embodiments.

1. An apparatus comprising:
a credit establishing element;
a regional security system wherein the credit providing element can be manually activated to establish at least one time duration wherein the status of the system switches from a first state to a second, different, monitored, state where the system is monitored from a displaced location for the at least one time duration, and, subsequent thereto, automatically returns to the first state.

2. An apparatus as in claim 1 where the credit establishing element includes a sensor responsive to a duration establishing event.

3. An apparatus as in claim 2 where the sensor is coupled by one of a wireless, or wired, medium to establish the time duration.

4. An apparatus as in claim 3 where the sensor includes at least one of a reader or an input screen.

5. An apparatus as in claim 1 where the credit establishing element includes a near field communication reader.

6. An apparatus as in claim 3 which includes establishing at least one of a real-time, or pre-paid account which can be drawn from to establish the at least one duration.

7. An apparatus as in claim 1 which includes an evaluator which evaluates charges by members of a plurality of monitoring services and assigns requested monitoring to a member of that plurality in accordance with at least one parameter.

8. An apparatus as in claim 7 where the parameter is selected from a class which includes at least location and cost to implement the requested monitoring.

9. An apparatus as in claim 1 where a request for monitoring, can be entered or on-going monitoring, can be terminated from a location displaced from the security system

10. A security apparatus comprising:
a security system with at least an armed state and a disarmed state where the system operates in a first state without communicating with a monitoring service;
a credit establishing entity which via a wired or a wireless medium can transmit a demand for monitoring the system for a selected time duration; and
a supervisory element responsive to the demand and credit established by the entity, which elects one of, carrying out the monitoring process, or, determining that one of a plurality of monitoring stations should be assigned to monitor operation of the system for the time duration, subject to the established credit.

11. An apparatus as in claim 10 where the entity corresponds to one of a wired or, wireless communications device, a smart card, a computer or a tablet-type device.

12. An apparatus as in claim 10 where the system includes at least one of a touch screen, or a near field communications reader.

13. An apparatus as in claim 10 where the element makes a determination as to assigning one of the monitoring stations in accordance with at least one parameter selected from a class which includes cost, or location.

14. A method of providing third party monitoring of a security system on demand comprising:
establishing at least one date and duration during which third party monitoring of a security system, from a site displaced from the system, is required;
establishing an appropriate financial credit to address costs of the required monitoring;
evaluating which one of a plurality of monitoring stations should be selected to monitor the system, and, arranging to have the system monitored thereby in accordance with the at least one date and duration; and
terminating the monitoring in accordance with the established date and duration.

15. A method as in claim 14 where evaluating includes evaluating at least one of costs associated with members of the plurality, or locations of the members of the plurality.
